(19) United States
(12) Patent Application Publication
(10) Pub. No.: US 2020/0012756 A1
(43) Pub. Date: Jan. 9, 2020

(54) VISION SIMULATION SYSTEM FOR SIMULATING OPERATIONS OF A MOVABLE PLATFORM

(71) Applicant: SZ DJI TECHNOLOGY CO., LTD., Shenzhen (CN)

(72) Inventors: Yuewen MA, Shenzhen (CN); Kaiyong ZHAO, Shenzhen (CN); Shizhen ZHENG, Shenzhen (CN)

(21) Appl. No.: 16/577,295

(22) Filed: Sep. 20, 2019

Related U.S. Application Data
(63) Continuation of application No. PCT/CN2017/079988, filed on Apr. 11, 2017.

(51) Int. Cl. G06F 17/50

(52) U.S. Cl. CPC G06F 17/5009

(57) ABSTRACT

A method includes obtaining state data of a movable platform, scene data of an environment within which the movable platform is simulated, and parameters of one or more imaging sensors borne on the movable platform, varying one or more of the state data, the scene data, and the parameters to obtain varied data, and simulating visual data captured by the one or more imaging sensors based on the varied data for the one or more of state data, the scene data, and the parameters.

### CROSS-REFERENCE TO RELATED APPLICATION

This application is a continuation of International Application No. PCT/CN2017/079988, filed Apr. 11, 2017, the entire content of which is incorporated herein by reference.

### TECHNICAL FIELD

The disclosed embodiments relate generally to a vision simulation system for simulating and testing operations of a movable platform.

### BACKGROUND

Movable platforms such as unmanned aerial vehicles (UAVs) can be used for performing surveillance, reconnaissance, and exploration tasks for military and civilian applications. A movable platform usually is associated with a plurality of imaging sensors configured to capture visual images. Various vision-based algorithms can be used to process the captured visual images to obtain useful information for operating the movable platform, such as target tracking, obstacle avoidance, and/or image/video capturing. In order to test the robustness of the vision-based algorithms, vision simulation can be used to substitute the real-environment image capturing and processing because vision simulation is more cost-efficient and less time-consuming than real-environment image capturing, processing, and analyzing.

### SUMMARY

There is a need for a vision simulation system that simulates operations of a movable object platform in various simulated environments for simulating and testing the vision-based algorithms used for target tracking, obstacle avoidance, image/video capturing, and/or other suitable functionalities of the movable platform.

In accordance with some embodiments, a method for simulating visual data of a movable platform is disclosed. The method comprises obtaining state data of a movable platform, scene data of an environment within which the movable platform is simulated, and parameters of one or more imaging sensors borne on the movable platform. The method comprises varying one or more of the state data, the scene data, and the parameters to obtain varied data. The method further comprises simulating visual data captured by the one or more imaging sensors based on the varied data for one or more of state data, the scene data, and the parameters.

In accordance with some embodiments, a system may comprise one or more processors; memory; and one or more programs. The one or more programs are stored in the memory and configured to be executed by the one or more processors. The one or more programs including instructions for performing the operations of the above method. In accordance with some embodiments, a non-transitory computer-readable storage medium has stored therein instructions that, when executed by the electronic device, cause the electronic device to perform the operations of the above method.

In accordance with some embodiments, a method for evaluating vision-based algorithms is disclosed. The method comprises receiving a first set of data of a movable platform simulated within a virtual environment. The first set of data is determined by state data of the movable platform and scene data of the environment. The method comprises obtaining a second set of data of the movable platform. The second set of data is determined based on visual data that is simulated from the state data, the scene data, and parameters of one or more imaging sensors borne on the movable platform. The method further comprises determining a first indicator corresponding to the first set of data and a second indicator corresponding to the second set of data. The method also comprises outputting a comparison result between the first indicator and the second indicator.

In accordance with some embodiments, a system may comprise one or more processors; memory; and one or more programs. The one or more programs are stored in the memory and configured to be executed by the one or more processors. The one or more programs including instructions for performing the operations of the above method. In accordance with some embodiments, a non-transitory computer-readable storage medium has stored therein instructions that, when executed by the electronic device, cause the electronic device to perform the operations of the above method.

### BRIEF DESCRIPTION OF THE DRAWINGS

FIG. 1 illustrates a movable platform simulation system for simulating operations of a movable platform, in accordance with some embodiments.

FIG. 2 illustrates an exemplary computing device for simulating operations of a movable platform, in accordance with some embodiments.

FIG. 3 is a block diagram illustrating a vision simulator for simulating visual data, in accordance with some embodiments.

FIG. 4 is a flow diagram illustrating a method of simulating visual data of a movable platform, in accordance with some embodiments.

FIG. 5 is a flow diagram illustrating a method of evaluating vision-based algorithms for a movable platform, in accordance with some embodiments.

FIG. 6A is an illustrative interface for visualizing operations of a movable platform simulated by a vision simulator of the movable platform simulation system, in accordance with some embodiments.

FIGS. 6B and 6C are illustrative interfaces for visualizing comparison results between a first indicator and a second indicator as discussed with reference to the method illustrated in FIG. 5, in accordance with some embodiments.

FIGS. 7A-7C are flow diagrams illustrating a method for simulating, by a vision simulator, visual data of a movable platform, in accordance with some embodiments.

FIGS. 8A-8C are flow diagrams illustrating a method for evaluating vision-based algorithms of a movable platform, in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

The following description uses an unmanned aerial vehicle (UAV) (e.g., a copter) as an example of a movable platform. UAVs include, e.g., fixed-wing aircrafts and rotary-wing aircrafts such as helicopters, quadcopters, and aircraft having other numbers and/or configurations of rotors. In some embodiments, the movable platform also includes, but is not limited to, a handheld gimbal with a camera and image processing capabilities, a self-driving car (i.e., an autonomous car, a driverless car), a virtual reality (VR) headset, and an augmented reality (AR) headset. It will be apparent to those skilled in the art that other types of movable platforms may be substituted for UAVs as described below, such as a mobile phone, a tablet, or a remote control.

Conventionally, various types of data, such as state data, visual data, and operational parameters, obtained from UAV operations are used to develop vision-based algorithms. The developed vision-based algorithms are tested on a flight controller of a UAV by operating the UAV under various circumstances in real environments. Various types of data are collected during these tests and are compared with the corresponding data used to develop the vision-based algorithms so as to test the accuracy and robustness of the vision-based algorithms. However, due to the limited data availability from UAV operations, and the time-consuming, costly, and demanding processes for testing the UAV in real environments, the above processes for developing and testing the vision-based algorithms are inefficient, expensive, and with low accuracy. Thus there is a need for efficient and effective method of testing the robustness of the vision-based algorithms.

The present disclosure provides techniques related to providing simulated visualization of movable platform operations, and testing vision-based algorithms associated with the operations of the movable platform. In some embodiments, a movable platform simulation system includes a state simulator that implements one or more models, e.g., movable platform models, sensor models, and/or environment models, to simulate operations and related states of a virtual movable platform. In some embodiments, the movable platform simulation system further includes a vision simulator that simulates visual data from perspectives of one or more virtual imaging sensors associated with the virtual movable platform. The vision simulator can realistically simulate the visual data to include various types of image defects that mimic real image defects received from one or more imaging sensors borne on a real movable platform. The simulated visual data can be used as input to various vision-based algorithms, and/or for testing various hardware components such as movable platforms, remote controllers, one or more imaging sensors, and the like.

In some embodiments, vision-based algorithms are used to compute operation data of the movable platform under various circumstances, such as target tracking and/or obstacle avoidance. In some embodiments, the computed data obtained using the vision-based algorithms is evaluated against the ground truth data obtained from the state simulator to verify the accuracy and robustness of the vision-based algorithms. By using the movable platform simulation system as discussed in the present disclosure, it is efficient, effective, and economic to simulate operations of the movable platform and to test various vision-based algorithms associated with operations of the movable platform.

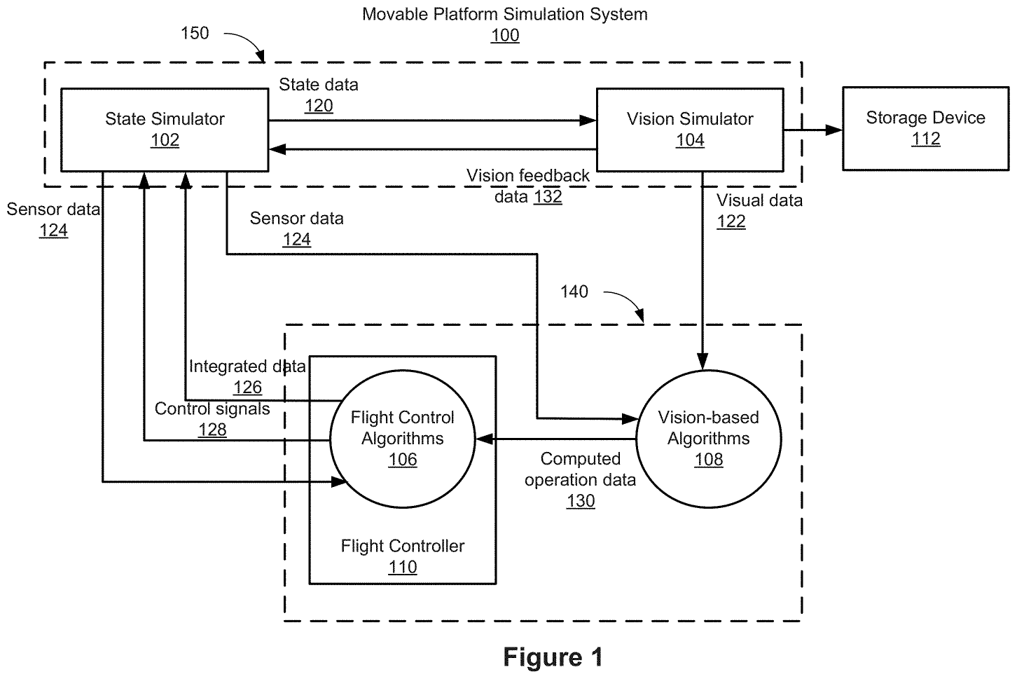

FIG. 1 illustrates a movable platform simulation system 100 for simulating operations of a movable platform, in accordance with some embodiments. In some embodiments, the movable platform simulation system 100 includes a plurality of components (e.g., software and/or hardware components) including a state simulator 102, a vision simulator 104, flight control algorithms 106, vision-based algorithms 108, and a flight controller 110 that are communicably coupled to each other. In some embodiments, the movable platform simulation system 100 further includes a storage device 112 for storing data obtained from the state simulator 102 (e.g., the simulated state data, or the ground truth data) and/or the vision simulator 104 (e.g., the simulated visual data). It should be noted that the plurality of components shown in FIG. 1 may be implemented on one or more computer systems. In some embodiments, the flight control algorithms 106, the vision-based algorithms 108, and the flight controller 110 are realized on one computer system 140 while the state simulator 102 and the vision simulator 104 are supported by the other computer system 150. In some other embodiments, each component is implemented on an individual computer system to test the reliability of the component and isolate problems associated with one component from those associated with another component for debugging purpose. In yet some other embodiments, all the components are implemented on one computer system to mimic a scenario most similar to the real-life operation condition when the moveable platform has integrated different functionalities together. Therefore, one skilled in the art would understand that the subsequent discussion is for illustrative purpose and it is not limited to a specific implementation of a particular component.

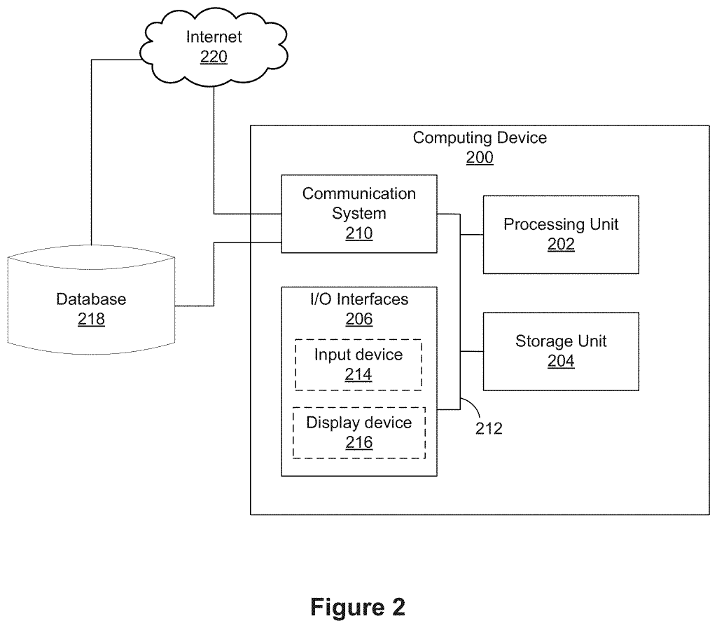

In some embodiments, the state simulator 102 is used for simulating one or more states of a movable platform by implementing a plurality of models. In some embodiments, the plurality of models includes movable platform models, sensor models, and/or environment models. In some embodiment, the state simulator 102 is implemented by a single computing device (e.g., the computing device 200, FIG. 2) or by multiple computing devices working together to perform the related actions. In some embodiments, one or more parts of the functionalities of the state simulator 102 are implemented via cloud computing. In some embodiment, the plurality of models are implemented using Matlab/Simulink software on the one or more computing devices.

In some embodiments, the state simulator 102 obtains control signals 128 generated by the flight control algorithms 106. In some embodiments, the state simulator 102 implements the movable platform models to determine the state data 120 (e.g., ground truth data) associated with simulated states (e.g., ground truth states) of the movable platform based on the data related to the control signals 128. In some embodiments, the state data 120 includes a location (e.g., coordinates), a displacement, a speed, an acceleration, orientation angles (or attitude), an angular velocity, and/or other types of state data. In some embodiments, the state data 120 also includes a flight mode information, including a tracking mode (e.g., tracking people, animals, or objects), a watching mode (e.g., watching one or more objects by adjusting gimbal configuration of a camera of an operating UAV in real time, such that the one or more objects remain in a field of view of the camera), a point of interest (POI) mode (e.g., controlling the UAV to hover about a user-defined point of interest and/or to film a 360 degree video of the point of interest), etc.

In some embodiments, the state simulator 102 implements sensor models to determine sensor data 124 based on the state data 120 and environment data (e.g., an altitude, a latitude, a longitude, a time, the Earth's magnetic field strength, and/or the like obtained by implementing environment models). In some embodiments, the sensor data 124 includes simulated measurements from a GPS receiver, inertial measurement units (IMU), an accelerometer, a gyroscope, a compass, a barometer, a thermometer, and/or other types of sensors associated with the movable platform. In some embodiments, the state simulator 102 sends the sensor data 124 to the flight control algorithms 106, so as to form a hardware-in-the-loop (HIL) simulation for testing and simulating operations of the movable platform.

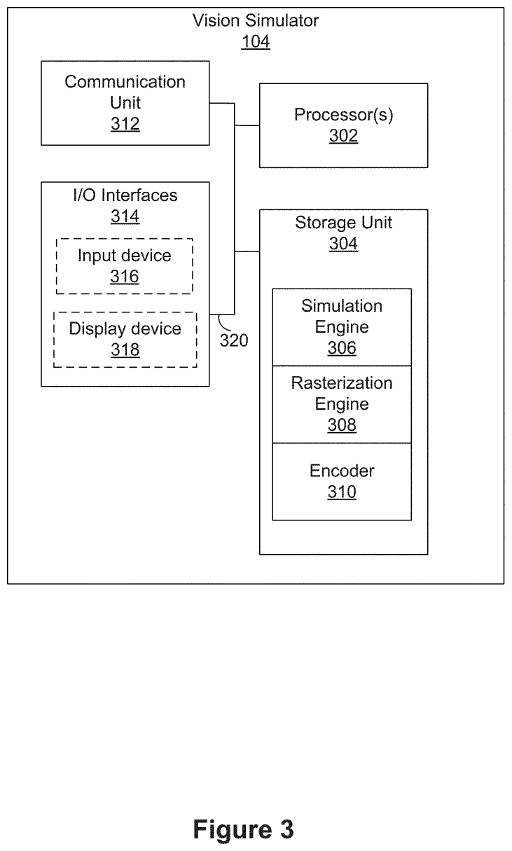

In some embodiments, the state simulator 102 transmits the state data 120 to the vision simulator 104 for processing and generating visual data 122 associated with simulated visualizations of the movable platform operations. In some embodiments, the vision simulator 104 is implemented by a single computing device (e.g., the vision simulator 104, FIG. 3) or by multiple computing devices working together to perform the related actions. In some embodiments, one or more parts of the functionalities of the vision simulator 104 are implemented via cloud computing.

In some embodiments, the visual data 122 includes simulated visual data from perspectives of one or more virtual imaging sensors associated with the movable platform, such as a primary imaging device (a payload) carried by a gimbal system and/or one or more imaging sensors (e.g., stereoscopic cameras, depth cameras such as time-of-flight (TOF) cameras, infrared cameras, ultrasonic imaging sensor, a plurality of cameras of a visual odometry system). The visual data 122 is simulated and rasterized based at least on the state data 120 of the movable platform and one or more parameters of the one or more virtual imaging sensors. In some embodiments, the parameters include intrinsic parameters of the one or more virtual imaging sensors, such as focal length, zooming information, depth of focus (DOF), and/or the like. In some embodiments, the parameters include extrinsic parameters, such as positional information (e.g., attitude) of the one or more imaging sensors.

In some embodiments, the visual data 122 includes data related to visualizing a user-defined environment (e.g., including mountains, sky, clouds, buildings, trees, objects, light, and/or the like) within which the movable platform is simulated to operate. In some embodiments, the visual data 122 includes 3-dimensional data for visualizing the environment. In some embodiments, the visual data 122 includes simulated visual data used for visualizing the simulated states of the movable platform. Examples of such visualization of the simulated states include a collision of the movable platform with an object in the environment, an impact from a collision, a snap of a wing, an impact of a force applied to the movable platform by the wind, and/or the like. In some embodiments, data related to such impact (e.g., vision feedback data 132) is transmitted to the state simulator 102.

In some embodiments, the vision simulator 104 transmits and stores data associated with each image frame in the storage device 112. Such stored data includes the visual data 122, the state data 120, parameters of the imaging sensors, depth information of one or more objects, pixel value of each pixel, coordinates of one or more objects, and/or the like of each image frame. In some embodiments, the data stored in the storage device 112 is used for testing and evaluating the vision-based algorithms 108.

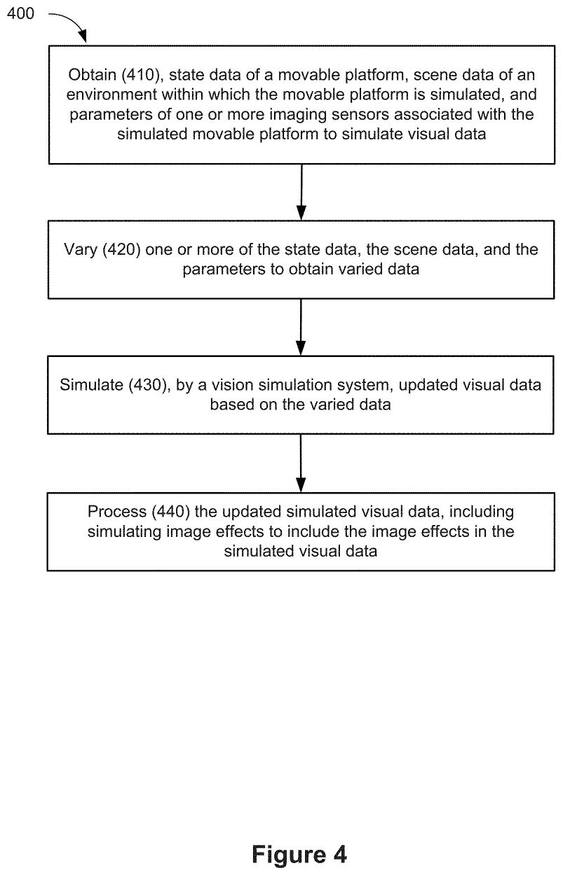

In some embodiments, the vision simulator 104 further processes the visual data 122 to include one or more types of image defects (e.g., image noise, image distortion, and/or improper brightness) that mimic real image defects received from real imaging sensors borne on a movable platform. Detailed descriptions of imaging processing by the vision simulator 104 are provided below with reference to FIGS. 3 and 4.

In some embodiments, the flight controller 110 includes one or more user input devices for receiving control commands from a user. The control commands can be used for adjusting states of the movable platform, for operating the movable platform, and/or for adjusting intrinsic parameters and/or extrinsic parameters of one or more imaging sensors associated with the movable platform.

In some embodiments, the flight control algorithms 106 generate control signals 128 based on the sensor data 124 received from the state simulator 102, control commands received from the flight controller 110, and computed operation data 130 received from the vision-based algorithms 108. In some embodiments, the control signals 128 include pulse-width modulation (PWM) signals. In some embodiments, the control signals 128 include data generated based on the PWM signals and for controlling three-phase (or AC) electric power including low voltage source that is used for controlling one or more motors of the movable platform, so as to effectuate certain movement(s) and/or spatial disposition(s) of the movable platform. For example, the control signals 180 can be used for accelerating, decelerating, turning, or halting the movable platform. The control signals 180 can also be used for adjusting the orientation of the movable platform, and/or the orientation of a gimbal system borne on the movable platform. In some embodiments, the flight control algorithms 106 are executed on the logic onboard the movable platform, such as the login of the flight controller 110 as shown in FIG. 1.

In some embodiments, the flight control algorithms 106 integrates the sensor data 124 from the state simulator 102 and the computed operation data 130 from the vision-based algorithms 108 to obtain integrated data 126 using, e.g., Kalman filter, extended Kalman filter, or any suitable sensor fusion algorithms. In some embodiments, the integrated data 126 includes a position, an orientation, an angular velocity, a linear velocity, an angular acceleration, a linear acceleration, a relative position between the movable platform and an object (e.g., a target) in the environment, a relative velocity between the movable platform and an object in the environment, and/or the like. It is noted that the states of the movable platform represented by the integrated data 126 are different from the simulated state (also referred to as ground truth state) associated with the state data 120. In some embodiments, the flight control algorithms 106 transmit the integrated data 126 to the state simulator 102.

In some embodiments, the vision-based algorithms 108 is used for performing various operations using the movable platform, such as navigation, mapping, collision avoidance, path planning, target tracking, and/or the like. In some embodiments, the vision-based algorithms 108 include simultaneous localization and mapping (SLAM) algorithm for mapping, visual odometry (VO) algorithm for determining position and orientation of the movable platform, and/or the like. In some embodiments, the vision-based algorithms 108 are executed on the flight controller 112. Alternatively, the vision-based algorithms 108 are executed on a separate computing device distinct from the flight controller 112.

In some embodiments of a HIL simulation scenario, the movable platform simulation system 100 generates a virtual movable platform and associated virtual sensors (e.g., virtual GPS, virtual gimbal, virtual gyroscope), and provides the visual data 122 to the logic onboard the movable platform (e.g., comprised in flight controller 110 or vision-based algorithms 108). In some embodiments, the visual data 122 may also include non-visual information (e.g., a UAV position, onboard camera orientation). In some embodiments, the logic onboard the movable platform computes operation data 130 using the vision-based algorithms 108 based on the simulated sensor data 124 received from the state simulator 102 and the visual data 122 received from the vision simulator 104. In some embodiments, the computed operation data 130 includes control commands for actuating the movable platform to perform one or more operations. In some embodiments, the computed operation data 130 includes state data of the virtual movable platform in the simulated operations (such as navigation, mapping, collision avoidance, path planning, target tracking, and/or the like). For example, the computed operation data 130 includes a position or an orientation and/or a velocity of the virtual simulated movable platform. In some embodiments, the computed operation data 130 can be evaluated against the simulated state data 120 (e.g., the ground truth data) to test and improve the vision-based algorithms 108. In some embodiments, the computed operation data 130 is transmitted to the flight control algorithms 106.

In some embodiments, the state simulator 102 and the vision simulator 104 are implemented on two separate computing devices. Details of a computing device for running the state simulator 102 or the vision simulator 104 are illustrated with reference to FIG. 2. In some embodiments, the data communication between the state simulator 102 and the vision simulator 104 uses a User Datagram Protocol (UDP). In some embodiments, the flight control algorithms 106 and the vision-based algorithms are executed on an integrated logic onboard a movable platform (e.g., in the flight controller 110). In some embodiments, the data communication between the integrated logic onboard the movable platform and the state simulator 102 uses Universal Asynchronous Receiver/Transmitter (UART) interfaces, and/or a Universal Serial Bus (USB)-to-UART converter. In some embodiments, the flight control algorithms 106 transmits the control signals 128 to the state simulator 102 using an electronic speed control (ESC) interface. For example, the ESC) interface takes the PWM signals as input, and outputs the control signals 128 for controlling one or more motors of the movable object, so as to effectuate certain movement(s) and/or spatial disposition(s) of the movable object. In some embodiments, the data acquisition system of the state simulator 102 includes a NI PCI6602 data acquisition board for receiving the control signals 128. In some embodiments, the vision simulator 104 transmits the visual data 122 to the vision-based algorithms 108 using a mobile industry processor interface (MIPI) transmission or a universal serial bus (USB) transmission. For example, low-resolution image data from one or more imaging sensors associated with the movable platform is transmitted using MIPI, and high-resolution image data from the primary imaging device on the payload of the movable platform is transmitted using USB. Other types of data communications between the components of the movable platform simulation system 100 include using wire/cable-based or wireless connections (e.g., wire, radio, Bluetooth, cloud connection, 4G/LTE, or WiFi), a secure digital (SD) card or a USB drive, a file transmission, a transmission control protocol (TCP), a user datagram protocol (UDP), a UDP-based data transfer protocol (UDT), or a Web socket protocol.

FIG. 2 illustrates an exemplary computing device 200 for simulating operations of a movable platform, in accordance with some embodiments. In some embodiments, the computing device 200 is provided by the entity that provides the state simulator 102, the entity that provides the vision simulator 104, or a different entity (e.g., cloud service provider). In some embodiments, the computing device 200 comprises a number of components, such as a storage unit (e.g., memory 204) and a processing unit 202 (e.g., one or more processors), some of which may be optional. In some embodiments, the computing device 200 is implemented as or as a part of a variety of devices, such as a computer, a server, a tablet, a mobile phone, a network device, a controller, a satellite, a signal tower, etc. In some embodiments, the storage unit 204 is implemented as transitory and/or non-transitory storage media or memories configured to store data, logic, code, and/or program instructions executable by the processing unit 202 for performing one or more routines or functions, and/or steps and method, such as simulation or rasterization.

In some embodiments, the storage unit 204 comprises instructions for implementing a simulation module (e.g., for the state simulator 102), or a rasterization module (e.g., for the vision simulator 104). In some embodiments, the rasterization module or portions of it may be implemented by hardware (e.g., application-specific integrated circuit (ASIC), graphics processing unit (GPU), field-programmable gate array (FPGA)), or a combination of both hardware and software. In some embodiments, the rasterization module includes, for example, Unreal Engine, Unity 3D, or CryEngine. In some embodiments, the rasterization module may be configured to render images based on raw images, e.g., converting a 3D scene to a 2D image for display. In some embodiments, the rasterization module is a part of the vision simulator 104 as described with reference to FIG. 1. In some embodiments, the storage unit 204 comprises instructions perform one or more methods described herein, e.g., method 400, or method 500.

In some embodiments, the computing device 200 includes the processing unit 202, the memory 204, a communication system 210, and one or more communication buses 212 for interconnecting these components. In some embodiments, the computing device 200 includes input/output (I/O) interfaces 206, e.g., display 216 and/or input device 214. In some embodiments, the computing device 200 is communicatively connected to a database 218 (e.g., via the communication system 210) and/or the computing device 200 includes the database 218 (e.g., the database 218 is connected to communication bus 212). In some embodiments, the communication system 210 includes one or more network or other communications interfaces.

FIG. 3 is a block diagram illustrating the vision simulator 104 for simulating the visual data 122, in accordance with some embodiments. In some embodiments, the vision simulator 104 corresponds to a physical system or physical objects. For example, the vision simulator 104 is embodied as a specialized computer or server system. For another example, the vision simulator 104 is a computer (e.g., the computing device 200, FIG. 2) comprising one or more physical processors programmed by computer program instructions that, when executed, cause the one or more physical processors to perform one or more methods described in this disclosure. For yet another example, the vision simulator 104 is implemented as an application on a computer, simulator, or smart device (e.g., smart phone or tablet). For yet another example, the vision simulator 104 is implemented on or as a part of a single device, e.g., a movable platform, a controller of the movable platform, a virtual reality helmet, a simulator, a pair of glasses, a contact lens, a wearable device, etc. For yet another example, the vision simulator 104 is implemented by more than one device or via cloud computing.

In some embodiments, the vision simulator 104 includes I/O interfaces 314, a communication unit 312, a processing unit 302, and a storage unit 304, some of which may be optional. In some embodiments, the I/O interfaces 314 include an input device 316 and a display device 318. In some embodiments, the display device 318 and/or the I/O interfaces 314 can be optional when the vision simulator 104 is a server box. The components of the vision simulator 104 may be operatively connected to each other via a bus 320 or other types of communication channels. The components of the vision simulator 104 may be physical components. In some embodiments, the vision simulator 104 includes many more components than those shown in FIG. 3. However, it is not necessary that all of these components be shown in order to disclose an illustrative embodiment.

In some embodiments, the I/O interfaces 314 include a keyboard, a printer, a display, a touch screen, a microphone, etc. In some embodiments, the I/O interfaces 314 are configured to input/output signals to/from the vision simulator 104. For example, the I/O interfaces 314 is configured to provide a user interface, e.g., a joystick or a touch screen to receive signals for changing a viewing angle of simulated images.

In some embodiments, the communication unit 312 includes connectors for wired communications, wireless transmitters and receivers, and/or wireless transceivers for wireless communications. The communications may comprise control signals and/or data. The connectors, transmitters/receivers, or transceivers may be configured for two-way communication between the vision simulator 104 and various devices (e.g., the state simulator 102, and/or the logic onboard the movable platform that provides the vision-based algorithms 108). For example, the communication unit 312 may send and receive operating signals and/or data to and from the movable platform or the computing device providing the state simulator 102.

In some embodiments, the display 318 may be configured to provide visual data to a user. The display 318 may be optional. The provided visual data may be raw visual data, rendered visual data, simulated visual data, transformed visual data, and so on. Such data may include audio, image, and video obtained by executing one or more steps in one or more methods described herein. The visual data may also be controllable via a user interface, e.g., the I/O interfaces 314, to manipulate, edit, or otherwise use the visual data based on user inputs.

In some embodiments, the storage unit 304 may include transitory and/or non-transitory storage media or memories configured to store data, logic, code, and/or program instructions executable by the processing unit 302 for performing one or more routines or functions, and/or steps and methods disclosed herein. The storage unit 304 may include one or more memory units (e.g., flash memory card, random access memory (RAM), read-only memory (ROM), and the like). In some embodiments, inputs from the I/O interfaces 314 can be conveyed to and stored within the memory units of the storage unit 304. Although FIG. 3 depicts a single memory 304, one of skill in the art would appreciate that this is not intended to be limiting, and that the vision simulator 104 may include a plurality of processing units and/or memory units of the memory.

In some embodiments, the storage unit 304 may include instructions for implementing a simulation engine 306, a rasterization engine 308, and an encoder 310. The processing unit 302 may be configured to execute the instructions stored in the storage unit 304 corresponding to the simulation engine 306, the rasterization engine 308, and the encoder 310. In some other embodiments, the simulation engine 306, the rasterization engine 308, and/or the encoder 310, or portions of the simulation engine 306, the rasterization engine 308, and/or the encoder 310 may be implemented in software, hardware (e.g., GPU, FPGA), or a combination of both.

In some embodiments, the simulation engine 306 may be configured to perform one or more methods described herein, e.g., method 400. The rasterization engine 308 and the encoder 310 may be optional. In some embodiments, the rasterization engine 308 or portions of it may be implemented by hardware (e.g., application-specific integrated circuit (ASIC), graphics processing unit (GPU), field-programmable gate array (FPGA)), or a combination of both hardware and software. The rasterization engine 308 may include, for example, Unreal Engine, Unity 3D, or CryEngine. The rasterization engine 308 may be configured to render images based on raw images, e.g., converting a 3D scene to a 2D image for display. In some embodiments, the encoder 310 may be configured to convert data, information, or signal from one format/code to another for the purposes of standardization, speed, or compression. In some embodiments, the compression standard used by the encoder 234 may include H.264, JPEG, or JPEG2000. The use of the compression standards may decrease the response time of generated data.

In some embodiments, the processing unit 302 may include one or more processors, such as a programmable processor (e.g., a central processing unit (CPU), FPGA, ASIC). In some embodiments, the processing unit 302 may include one or more GPUs and/or ASIC for fast and efficient generation of virtual data. The simulation engine 306 may be implemented as or as a part of the CPU or the GPU. In some embodiments, one or more components of the vision simulator 104, such as the simulation engine 306, may be configured to execute one or more instructions stored in the storage unit 304 to implement one or more methods described herein. The implemented methods may include simulating, rendering, or transforming visual data. Detailed descriptions of the methods are provided below with reference to FIG. 4.

FIG. 4 is a flowchart illustrating a method 400 for simulating the visual data 122, in accordance with some embodiments. In some embodiments, one or more steps of the method 400 are performed by a computing device, such as the vision simulator 104 as discussed with reference to FIGS. 1 and 3. In some other embodiments, one or more steps of the method 400 are performed by other computing device(s), such as the computing device 200 as discussed with reference to FIG. 2. Operations performed in FIG. 4 correspond to instructions stored in computer memories or other computer-readable storage mediums of the corresponding computing device(s). In some embodiments, the method 400 comprises a number of steps, some of which are optional or are rearranged in another order.

In some embodiments, the vision simulator 104 obtains (410) the state data 120 of a movable platform from the state simulator 102 as discussed with reference to FIG. 1.

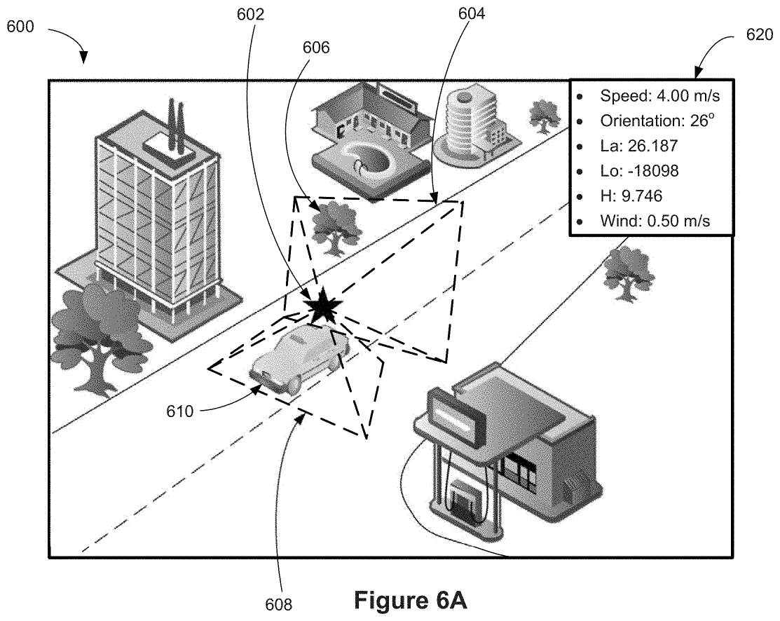

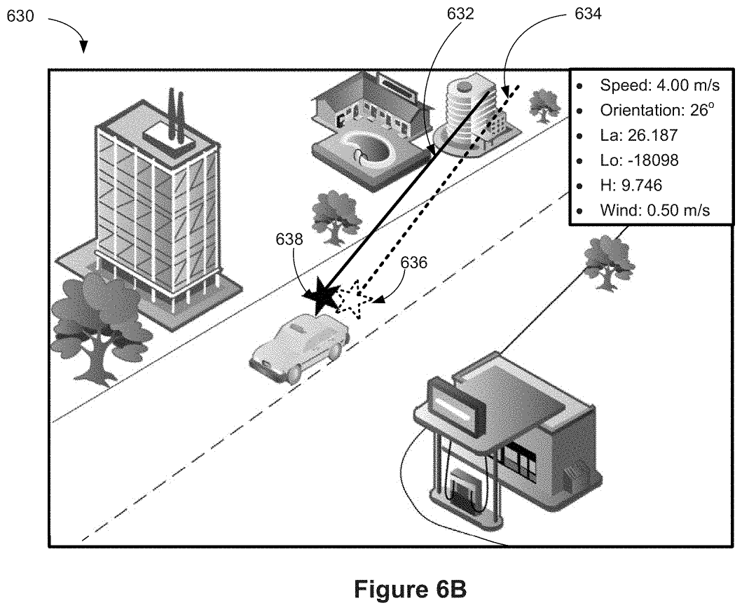

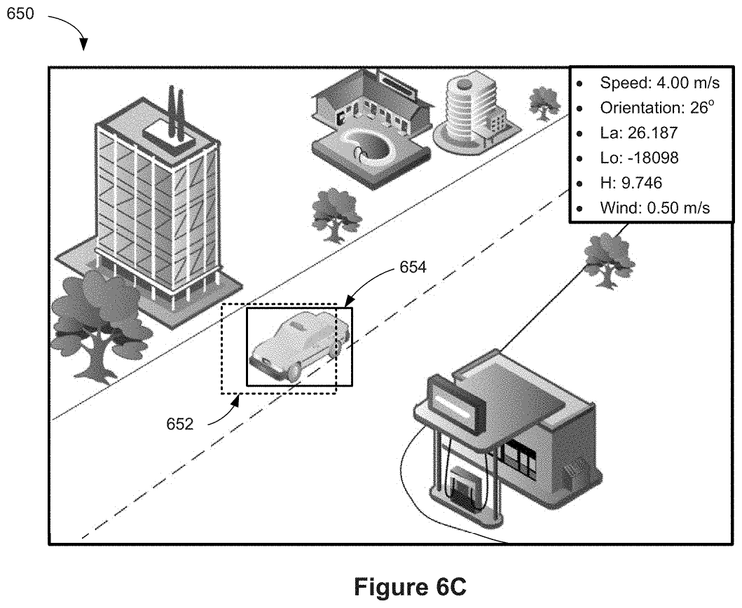

In some embodiments, the vision simulator 104 also obtains (410) scene data of a virtual environment within which the movable platform is simulated. For example, the virtual environment is a user-defined environment, e.g., including mountains, sky, clouds, buildings, trees, objects, light, and/or the like. In some embodiments, the scene data is configurable and can be configured by a user (e.g., based on a user instruction received using one or more input devices 316), a configuration file, a real-time setting, etc. In some embodiments, the scene data includes data associated with static objects in the environment, such as mountains, buildings (e.g., buildings in FIG. 6A), trees (e.g., trees in FIG. 6A), and/or the like. In some other embodiments, the scene data includes data associated with moving objects in the environment, such as moving people, cars (e.g., cars in FIG. 6A), hot balloons, and/or the like. In some embodiments, the scene data includes 3-dimensional data of the environment. In some embodiments, the scene data includes data related to weather condition and/or lighting condition in the environment.

In some embodiments, the vision simulator 104 further obtains (410) one or more parameters of one or more imaging sensors (also referred to as visual sensors, image sensors) associated with the simulated movable platform as discussed with reference to FIG. 1. In some embodiments, the one or more parameters of the imaging sensors are configurable and may be configured by a user, a configuration file, a real-time setting, etc. In some embodiments, the one or more parameters are obtained through a network, a memory transfer, a user-input (e.g., received using one or more input devices 316), control commands from the flight controller 110, and/or the like.

In some embodiments, the imaging sensors are virtual imaging sensors configured to capture virtual images. In some embodiments, a virtual imaging sensor includes a simulated lens and a simulated detector configured to capture virtual images through the simulated lens, the simulated lens corresponding to a physical lens of a physical imaging sensor, and the simulated detector corresponding to a physical detector of the physical visual sensor. In some embodiments, the one or more parameters are related to the optics (e.g., lenses) and/or the image sensors (e.g., detectors) of the virtual imaging sensor (e.g., camera). For example, the parameters related to the optics may include focal length, refractive index, and distortion model of the lenses (e.g., a model that relates the incident ray direction and the output ray direction); and the parameters related to the image sensors may include sensor size, photon noise, and heat noise. In some embodiments, properties of physical lenses and/or detectors, such as optical properties, material properties, and chemical properties, are simulated in the virtual imaging sensor to mimic physical imaging sensors.

In some embodiments, the vision simulator 104 obtains (410) the state data 120, the scene data, and the one or more parameters of the virtual imaging sensors associated with the simulated movable platform to simulate the visual data 122. In some embodiments, the simulation engine 306 of the vision simulator 104 is configured to simulate the visual data 122, and the rasterization engine 308 is configured to render images (e.g., as shown in FIG. 6A) based on the visual data 122. In some embodiments, the simulated visual data and the rendered images are from perspectives (e.g., fields of view) of the one or more virtual imaging sensors. In some embodiments, the visual data 122 includes data related to a virtual environment, such as an open space, a forest, a stadium, or the like. As discussed elsewhere herein, the data related to the virtual environment may be obtained from a user, or captured by another device outside the vision simulator 104, or from other sources (e.g., the Internet). In some embodiments, one or more 3D models stored in the storage unit 304 are used for simulating the data related to the virtual environment. In some embodiments, the virtual environment is simulated and rasterized from perspectives of a virtual imaging sensor associated with the virtual movable platform. In some embodiments, the vision simulator 104 extracts 3D scenes from one or more selected 3D models based on a current state (e.g., based on the state data 120) of the virtual movable platform and the one or more parameters of the one or more virtual imaging sensors.

In some embodiments, the vision simulator 104 varies (420) one or more data items of the state data, the scene data, and/or the operation parameters to obtain varied data. For example, the orientation or the position of the movable platform may change due to a change of a state of the movable platform. In another example, the user may change the scene data to test the virtual movable platform in a different environment. In yet another example, one or more operation parameters of the virtual imaging sensors, such as an orientation of the primary camera, may be changed.

In some embodiments, the vision simulator 104 simulates (430) the updated visual data based on the varied data of the state data 120, the scene data, and/or the one or more parameters of the virtual imaging sensors associated with the simulated movable platform.

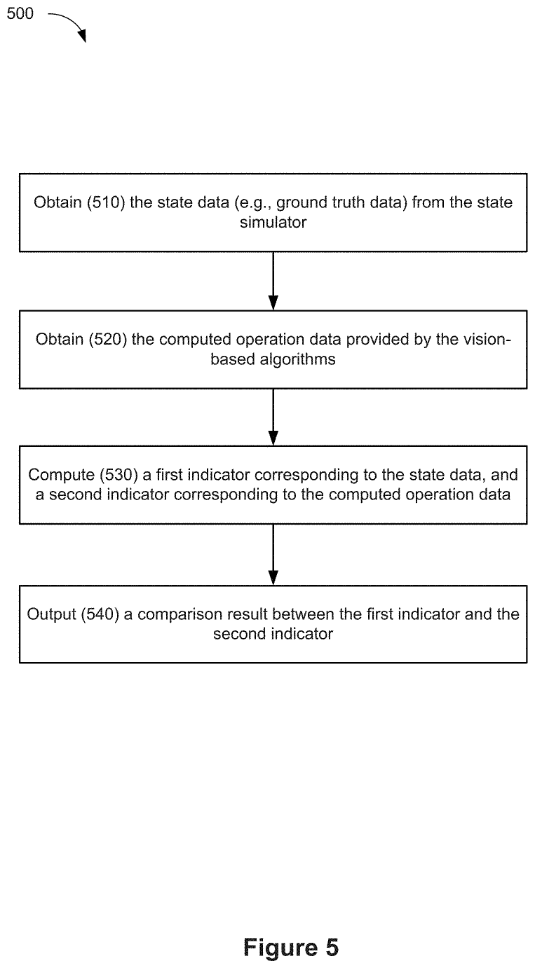

In some embodiments, the vision simulator 104 processes (440) the updated simulated visual data to simulate one or more image effects of the simulated visual data. In some embodiments, the simulated visual data is transformed to simulate an effect that mimics a corresponding effect of an image captured by a physical lens. For example, the vision simulator 104 may re-calculate, adjust, or modify the simulated visual data to simulate an effect of the one or more parameters. In some embodiments, the image effects include, for example, a distortion effect, a noise effect, an optical effect, a brightness effect, etc. In some embodiments, the one or more parameters of a virtual imaging sensor include one or more models for simulating the various image effects. By simulating the effect of the one or more parameters, the transformed visual data can allow better testing of vision-based algorithms (e.g., as discussed with reference to method 500 in FIG. 5), e.g., navigation, mapping, collision avoidance, path planning, tracking, etc.

In some embodiments, the one or more image defects include an image distortion effect. In some embodiments, the distortion effect includes a barrel distortion (e.g., of a fisheye lens), a pincushion distortion, or a mustache distortion. In some embodiments, the one or more parameters of the imaging sensor include a distortion model for simulating the optical aberration of a physical lens that creates the image distortion effect. In some embodiments, the vision simulator 104 simulates the image distortion effect based on the parameter corresponding to the distortion model to.

In some embodiments, the one or more image defects include a noise-related effect. In some embodiments, the noise-related effect is related to random variation of brightness or color information in images and may be related to sensor size, photon noise, and heat noise of the imaging sensors. In some embodiments, the one or more parameters of the imaging sensor include a model that is used for simulating the photon noise and heat noise, where the photon noise is related to brightness and the heat noise is related to exposure time.

In some embodiments, the simulated visual data is processed to provide uniform brightness in the images. In some embodiments, the vision simulator 104 calculates the average brightness of the simulated images, and adjusts the brightness of the images such that the simulated images mimic the uniform brightness in the images captured by a physical lens using an auto-exposure mode.

In some embodiments, the simulated image effects are added to the simulated visual data such that the simulated images mimic the images captured by a physical imaging sensor. For example, the noise values related to the simulated image effects are added to the simulated pixel values of the corresponding pixels to obtained transformed pixel values of the simulated images. In some embodiments, the noise values may be added uniformly to the simulated pixel values, according to a distribution (e.g., Gaussian distribution), or based on another configurable rule.

FIG. 5 is a flowchart illustrating a method 500 for testing and evaluating vision-based algorithms, in accordance with some embodiments. In some embodiments, one or more steps of the method 500 are performed by a computing device (e.g., the computing device 200, FIG. 2). In some other embodiments, one or more steps of the method 500 are performed by the logic onboard the movable platform, such as inside the flight controller or other suitable computing device(s) onboard the movable platform. Operations performed in FIG. 5 correspond to instructions stored in computer memories or other computer-readable storage mediums of the corresponding computing device(s). In some embodiments, the computing device that performs method 500 provides the vision-based algorithms 108 as discussed in FIG. 1. In some embodiments, the computing device providing the vision-based algorithms 108 is different from the computing device that performs method 500. In some embodiments, the method 500 comprises a number of steps, some of which are optional or are rearranged in another order.

In some embodiments, the computing device obtains (510) the state data 120 (e.g., the ground truth data) from the state simulator 104. In some embodiments, the computing device obtains (520) the computed operation data 130 provided by the vision-based algorithms 108. In some embodiments, the operation data 130 are computed by the vision-based algorithms 108 based on the visual data 122 simulated by the vision simulator 104. In some embodiments, the visual data 122 includes one or more image effects simulated by the vision simulator 104 using the method 400. Details of the state data 120 and the computed operation data 130 are discussed with reference to FIG. 1.

In some embodiments, the computing device computes (530) a first indicator corresponding to the state data 120, and a second indicator corresponding to the computed operation data 130. Exemplary embodiments of the first indicator and the second indicator are illustrated with references to FIGS. 6B and 6C. In some embodiments, the first indicator and the second indicator include respective visual indicators (e.g., lines, boxes, highlighted regions, etc.) that visualize respective information subtracted from the corresponding data.

In some embodiments, the computing device outputs (540) a comparison result between the first indicator and the second indicator. For example as shown in FIG. 6B, SLAM algorithm or VO algorithm is used for computing the positions and orientations of the movable platform and the imaging sensor associated with the movable platform. The positions of the movable platform and the trajectories of the movable platform that are determined based on the state data 120 and the computed operation data 130 are illustrated using solid lines and dashed lines respectively in FIG. 6B. In another example as shown in FIG. 6C, during a target tracking simulation, the location of the target determined based on the state data 120 and the computed operation data 130 are illustrated using solid box and dashed box respectively in FIG. 6C. The comparison result between the first indicator and the second indicator can provide a convenient and direct view for testing and evaluating the vision-based algorithms. For example, when there is a significant difference between the first indicator and the second indicator, the vision-based algorithms can be modified and updated computed operation data 130 can be obtained using the modified vision-based algorithms. An updated second indicator corresponding to the updated computed operation data 130 can be computed and displayed in comparison with the first indicator to the user. This process can be repeated until the difference between the first indicator and the second indicator is within a predetermined acceptable range. The modified vision-based algorithms that generate operation data 130 corresponding to the acceptable second indicator can then be integrated into a system of a real movable platform for testing.

FIG. 6A is an illustrative interface 600 for visualizing operations of a movable platform simulated by a vision simulator of the movable platform simulation system 100 (e.g., FIG. 1), in accordance with some embodiments. In some embodiments, the interface 600 is displayed on the display device 318 of the vision simulator 104 or the display device 216 of the computing device 200. In some embodiments, the user can view and have direct user interaction through the interface 600 using the input device 316 or the input device 214 respectively. For example, a user can drag and/or tap on the display screen to zoom in/out, to select an object in the environment, and/or to view the simulated views from different viewing angles.

In some examples as shown in FIG. 6A, the interface 600 displays a movable platform 602 operated in an environment including one or more buildings, trees, and cars running on a street. In some embodiments, a first pyramid of vision 604 having an apex at the point 602 represents a field of view of one or more imaging sensors located at the front of the movable platform. For example, a pair of VO cameras located at the front of the movable platform can capture an image of a tree 606. In some other embodiments, the first pyramid of vision 604 represents a field of view of a primary imaging sensor borne on a payload of the movable platform, and an orientation of the primary imaging sensor is adjusted to face lower-front of the movable platform. In some embodiments, a second pyramid of vision 608 represents a field of view of one or more imaging sensors located at the bottom of the movable platform, such as a pair of VO cameras located at the bottom of the movable platform or the primary imaging sensor positioned to capture images of objects (e.g., a car 610) below the movable platform. Although not shown, the interface 600 can further visualize the visual data related to a collision between the movable platform and an object in the environment, the movable platform flying at a certain height, a torque generated from a collision, a snap of a wing, a force applied to the movable platform by the wind, etc.

In some embodiments as shown in FIG. 6A, in addition to the simulated image, one or more data items associated with the states of the movable platform, a simulated environment surrounding the movable object, and/or simulated sensor measurements can also be displayed, e.g., in real time of the simulation, in a panel 620 on the interface 600. For example, the panel 620 lists one or more data items selected from the visual data 120, the environment data, the scene data, the state data, and/or the sensor data. For example, as shown in FIG. 6A, the panel 620 lists a speed (i.e., velocity), an orientation angle, a latitude (La), a longitude (Lo), a height (H), and a wind speed (Wind) during the simulation of an operation of the movable object. In some other examples, the panel 620 lists dimensions and/or distances of one or more objects (e.g., a tree) detected in the simulated views.

In some embodiments, the user can directly adjust and/or input a number for a data item, such as a height of the movable platform. In response, the corresponding state of the movable platform, e.g., the height, will be changed during the simulation. In some embodiments, the user can directly interact with the simulated image to manipulate the simulation of the movable platform. For example, the user can circle an object, and in response, the movable platform simulation system 100 can simulate and display a target tracking mode of the movable platform.

FIGS. 6B and 6C are illustrative interfaces for visualizing comparison results between a first indicator and a second indicator as discussed with reference to method 500 of FIG. 5, in accordance with some embodiments. In some embodiments, the interfaces 630 (FIG. 6B) and 650 (FIG. 6C) are displayed on the display device 216 of the computing device 200.

In some embodiments as shown in FIG. 6B, vision-based algorithms, such as SLAM or VO algorithm, are used for computing operation data 130, including position/orientation of the movable platform and a moving trajectory of the movable platform. In some embodiments, the interface 630 displays the position/orientation 636 of the movable platform in a dashed star, and the moving trajectory 634 in a dashed line based on the computed operation data 130. In some embodiments, the interface 630 also displays the position/orientation 638 of the movable platform in a solid star and the moving trajectory 632 of the movable platform in a solid line based on the state data 120 (e.g., the ground truth data). The differences between the corresponding information subtracted from the computed operation data 130 and the state data 120 can be directly visualized on the interface 630. The accuracy and robustness of the vision-based algorithms can be conveniently evaluated based on the visualized comparison results. In some embodiments, when the vision-based algorithms are modified, the computed operation data 130 including the position/orientation 636 of the movable platform and the moving trajectory 634 can be updated in real time, and the indicators including the dashed start and the dashed line can be updated instantaneously on the interface 630 to visualize the effect of the modification of the vision-based algorithms.

In some embodiments as shown in FIG. 6C, vision-based algorithms can be used for computing operation data 130, for simulating tracking an object (e.g., a car) in the environment by the movable platform. In some embodiments, the interface 650 displays the position 652 of the tracking target (e.g., the car) in a dashed box, and the position 652 of the tracking target is determined based on the computed operation data 130. In some embodiments, the interface 650 also displays the position 654 of the tracking target (e.g., the car) in a dashed box, and the position 654 is determined based on the state data 120 (e.g., the ground truth data). The differences between the dashed box 652 obtained based on the computed operation data 130 and the solid box 654 obtained based on the state data 120 can be directly visualized on the interface 650. The accuracy and robustness of the vision-based algorithms can be evaluated based on the comparison result. In some embodiments, when the vision-based algorithms are modified, the computed operation data 130 can be updated in real time, and the indicators including the dashed box can be updated instantaneously on the interface 650 to visualize the effect of the modification of the vision-based algorithms.

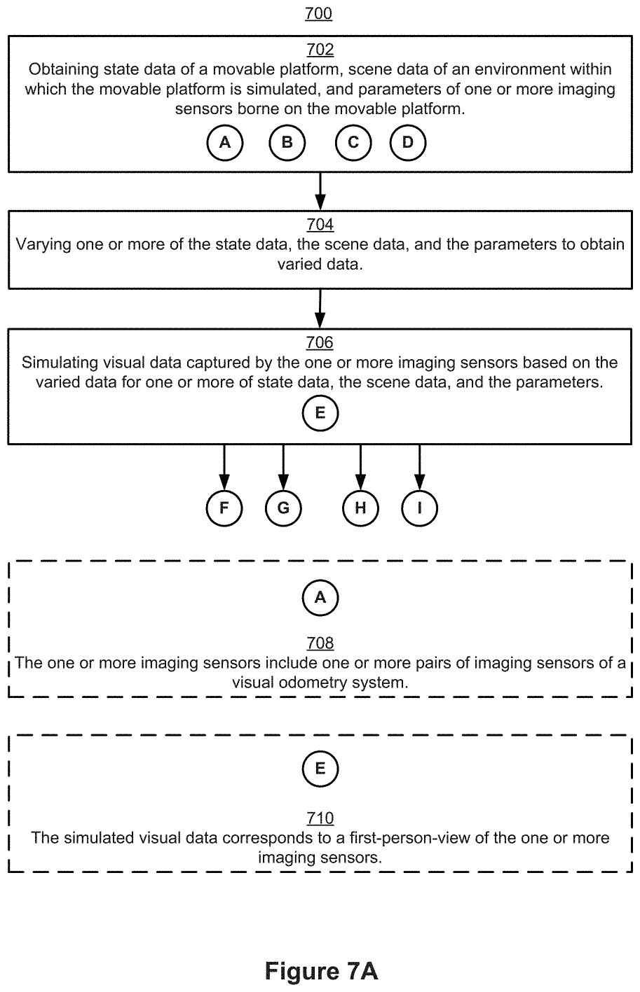

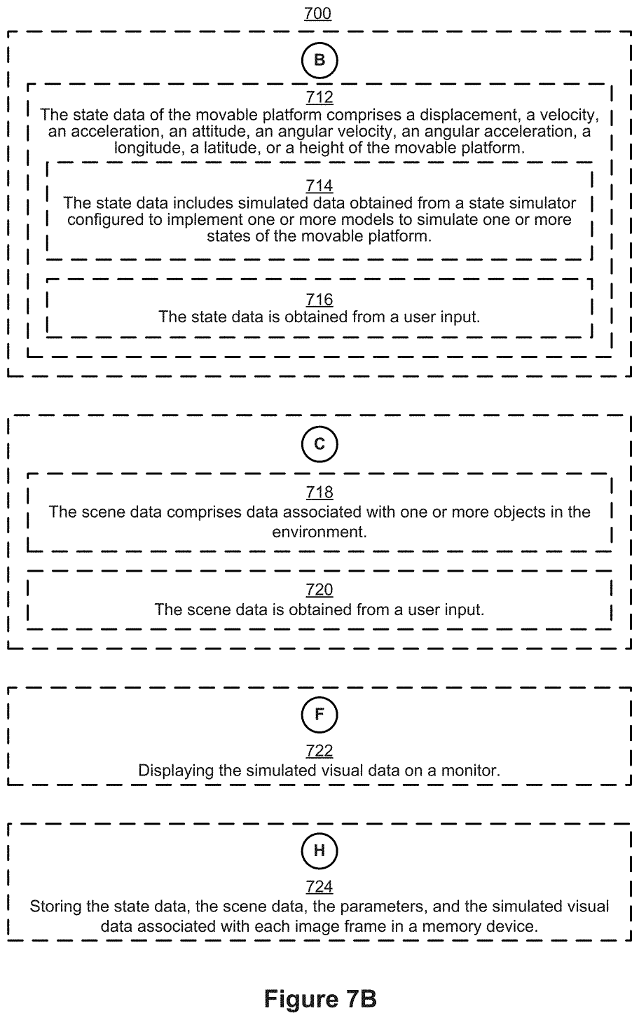

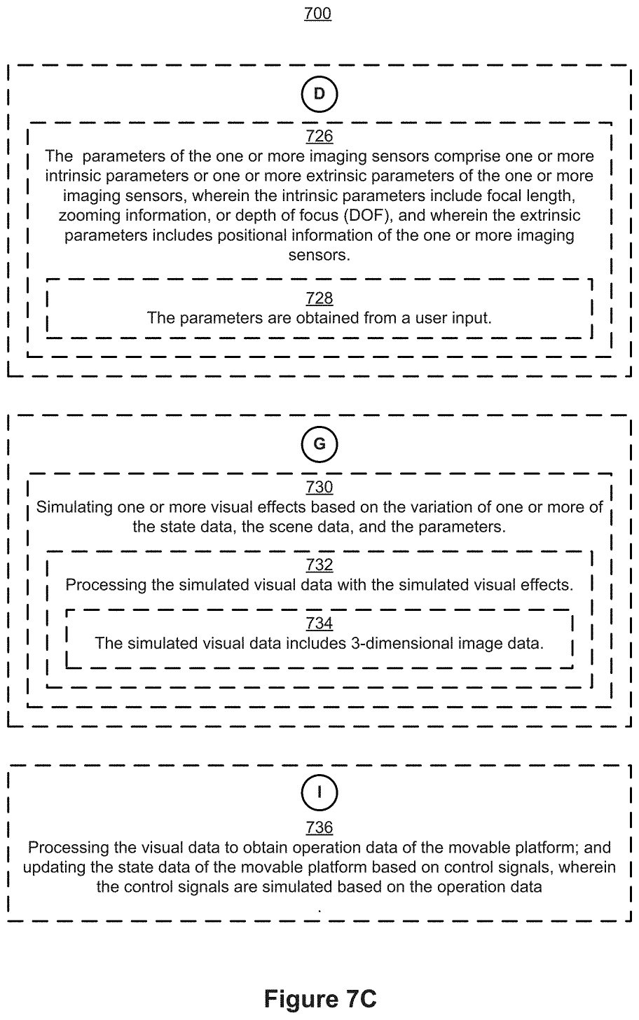

FIGS. 7A-7C are flow diagrams illustrating a method 700 for simulating, by the vision simulator 104, the visual data 122 of the movable platform, in accordance with some embodiments. In some embodiments, one or more steps of the method 700 are performed by a computing device, such as the vision simulator 104 as discussed with reference to FIGS. 1 and 3. In some other embodiments, one or more steps of the method 700 are performed by other computing device(s), such as the computing device 200 as discussed with reference to FIG. 2. Operations performed in FIG. 7 correspond to instructions stored in computer memories or other computer-readable storage mediums of the corresponding computing device(s).

The computing device obtains (702) the state data 120 of a movable platform, scene data of an environment within which the movable platform is simulated, and parameters of one or more imaging sensors borne on the movable platform.

In some embodiments, the one or more imaging sensors include (708) one or more pairs of imaging sensors of a visual odometry (VO) system. In some embodiments, the state data of the movable platform comprises (712) a displacement, a velocity, an acceleration, an attitude, an angular velocity, an angular acceleration, a longitude, a latitude, or a height of the movable platform. In some embodiments, the state data includes (714) simulated data obtained from a state simulator configured to implement one or more models to simulate one or more states of the movable platform. In some embodiments, the state data is obtained (716) from a user input. In some embodiments, the scene data comprises (718) data associated with one or more objects in the environment. In some embodiments, the scene data is obtained (720) from a user input. In some embodiments, the parameters of the one or more imaging sensors comprise (726) one or more intrinsic parameters or one or more extrinsic parameters of the one or more imaging sensors, wherein the intrinsic parameters include focal length, zooming information, or depth of focus (DOF), and wherein the extrinsic parameters includes positional information of the one or more imaging sensors. In some embodiments, the parameters are obtained (728) from a user input.

The computing device varies (704) one or more of the state data, the scene data, and the parameters to obtain varied data. The computing device simulates (706) visual data captured by the one or more imaging sensors based on the varied data for one or more of state data, the scene data, and the parameters.

In some embodiments, the simulated visual data corresponds (710) to a first-person-view of the one or more imaging sensors. In some embodiments, the computing device further displays (722) the simulated visual data on a monitor. In some embodiments, the computing device further simulates (730) one or more visual effects (e.g., an image distortion, image noise, etc.) based on the variation of one or more of the state data, the scene data, and the parameters. In some embodiments, the computing device further processes (732) the simulated visual data with the simulated visual effects. In some embodiments, the simulated visual data includes (734) 3-dimensional image data.

In some embodiments, the computing device further stores (724) the state data, the scene data, the parameters, and the simulated visual data associated with each image frame in a memory device. In some embodiments, the computing device further processes (736) the visual data to obtain operation data of the movable platform, and updates (736) the state data of the movable platform based on control signals, which are simulated from the operation data. The visual data may be processed using the vision-based algorithms to obtain the operation data (e.g., as shown in FIG. 1).

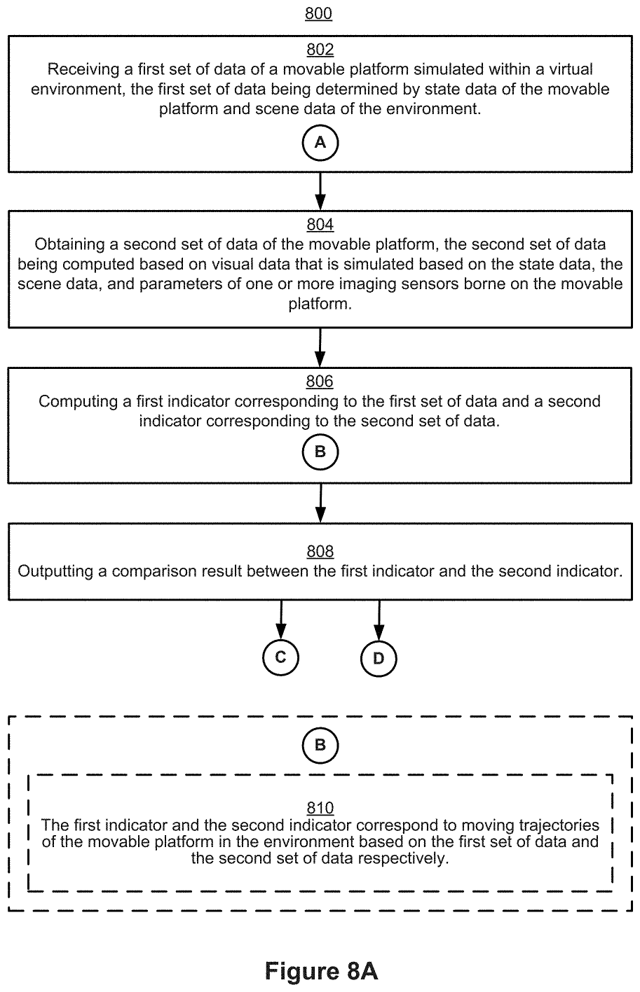

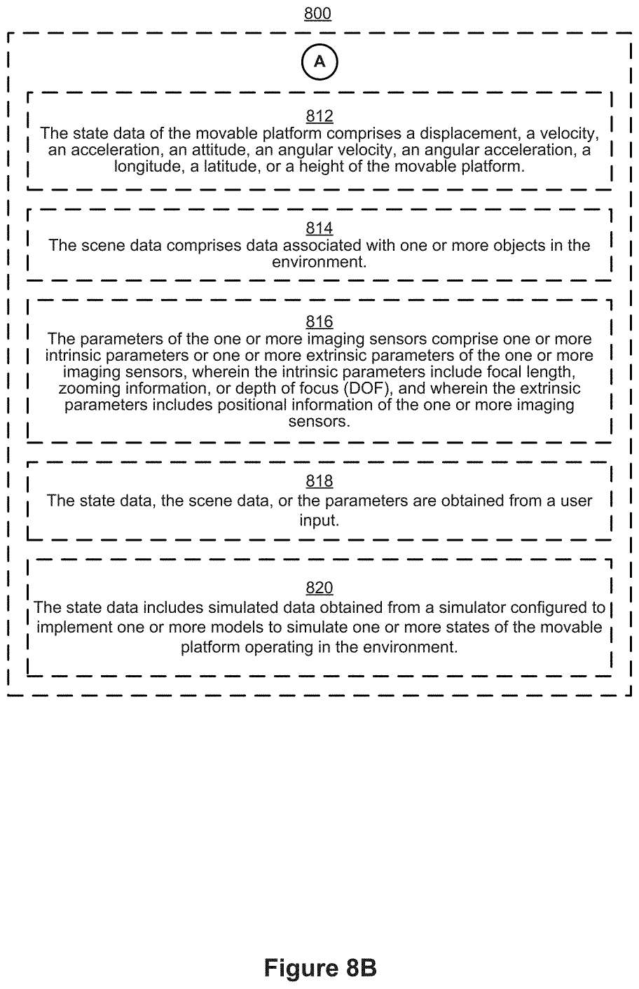

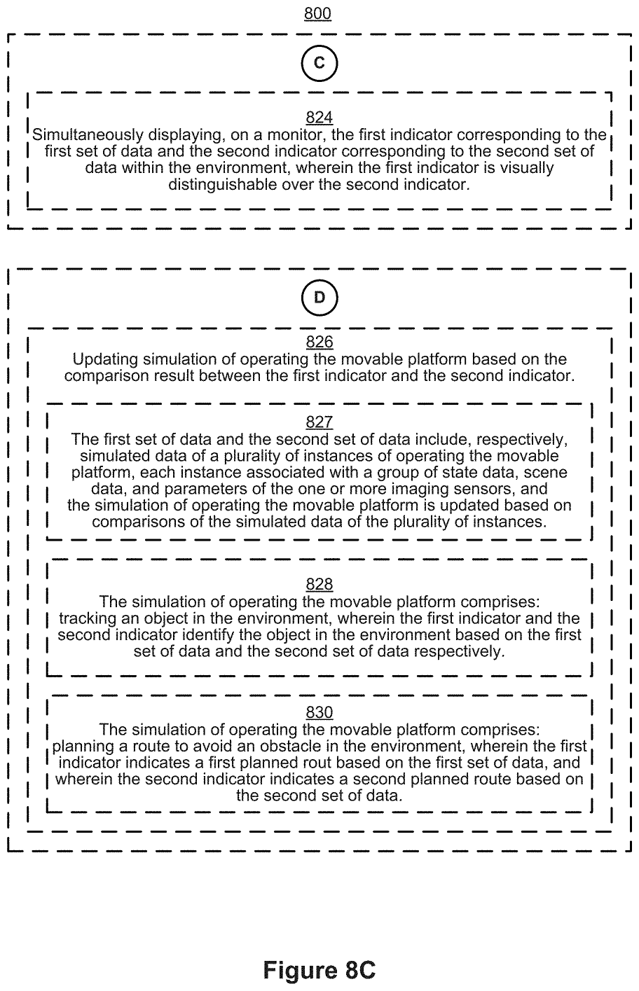

FIGS. 8A-8C are flow diagrams illustrating a method 800 for evaluating vision-based algorithms of a movable platform, in accordance with some embodiments. In some embodiments, one or more steps of the method 800 are performed by the computing device 200 as discussed with reference to FIG. 2. Operations performed in FIG. 8 correspond to instructions stored in computer memories or other computer-readable storage mediums of the corresponding computing device(s).

The computing device receives (802) a first set of data (e.g., the state data 120 and/or the scene data) of a movable platform simulated within a virtual environment. The first set of data is determined by state data of the movable platform and scene data of the environment. In some embodiments, the state data of the movable platform comprises (812) a displacement, a velocity, an acceleration, an attitude, an angular velocity, an angular acceleration, a longitude, a latitude, or a height of the movable platform. In some embodiments, the scene data comprises (814) data associated with one or more objects in the environment. In some embodiments, the parameters of the one or more imaging sensors comprise (816) one or more intrinsic parameters or one or more extrinsic parameters of the one or more imaging sensors, wherein the intrinsic parameters include focal length, zooming information, or depth of focus (DOF), and wherein the extrinsic parameters includes positional information of the one or more imaging sensors. In some embodiments, the state data, the scene data, or the parameters are obtained (818) from a user input. In some embodiments, the state data includes (820) simulated data obtained from a simulator configured to implement one or more models to simulate one or more states of the movable platform operating in the environment.

The computing device obtains (804) a second set of data of the movable platform. The second set of data (e.g., the computed operation data 130) is determined based on visual data (e.g., the visual data 122) that is simulated from the state data, the scene data, and parameters of one or more imaging sensors borne on the movable platform.

The computing device computes (806) a first indicator corresponding to the first set of data and a second indicator corresponding to the second set of data. In some embodiments, the first indicator and the second indicator correspond (810) to moving trajectories of the movable platform in the environment based on the first set of data and the second set of data respectively. In some embodiments, the first indicator and the second indicator highlights a target object being tracked.

The computing device outputs (808) a first indicator a comparison result between the first indicator and the second indicator. In some embodiments, the computing device further simultaneously displays (824), on a monitor, the first indicator corresponding to the first set of data and the second indicator corresponding to the second set of data within the environment. The first indicator is visually distinguishable over the second indicator. In some embodiments, the computing device further optimizes (826) simulation of operating the movable platform based on the comparison result between the first indicator and the second indicator. For instance, the computing device modifies an operation of the movable platform based on the comparison result between the first indicator and the second indicator by changing the movable platform's moving direction, moving speed, etc., in order to reduce the difference between the two indicators. Note that this modification may or may not be driven by an additional user input. The effect of this modification is then simulated with the computing device updating the second set of data of the movable platform in accordance with the modified operation. This process may be repeated until the comparison result suggests that a difference between the first indicator and the second indicator is within an accepted threshold. The number of iterations of this process may be used for evaluating the performance of an algorithm used for controlling the movable platform and providing guidance of how to improve the algorithm. In some embodiments, the first set of data and the second set of data include (827), respectively, simulated data of a plurality of instances of operating the movable platform. Each instance is associated with a group of state data, scene data, and parameters of the one or more imaging sensors. The simulation of operating the movable platform is updated (827) based on comparisons of the simulated data of the plurality of instances. For example, a plurality of comparison results between first indicators and corresponding second indicators are displayed on the interface 630 or interface 650. Each pair of the first indicator and second indicator is obtained from the respective state data and the corresponding computed operation data computed using a respective vision-based algorithm. The pair of the first indicator and second indicator having the least difference corresponds to the most accurate vision-algorithm.

In some embodiments, the simulation of operating the movable platform comprises (828) tracking an object in the environment. The first indicator and the second indicator identify the object in the environment based on the first set of data and the second set of data respectively. In some embodiments, the simulation of operating the movable platform comprises (830) planning a route to avoid an obstacle in the environment. The first indicator indicates a first planned route based on the first set of data, and the second indicator indicates a second planned route based on the second set of data.

Many features of the present disclosure can be performed in, using, or with the assistance of hardware, software, firmware, or combinations thereof. Consequently, features of the present disclosure may be implemented using a processing system. Exemplary processing systems (e.g., processor(s) the one or more computing devices) include, without limitation, one or more general purpose microprocessors (for example, single or multi-core processors), application-specific integrated circuits, application-specific instruction-set processors, field-programmable gate arrays, graphics processors, physics processors, digital signal processors, coprocessors, network processors, audio processors, encryption processors, and the like.

Features of the present disclosure can be implemented in, using, or with the assistance of a computer program product, such as a storage medium (media) or computer readable storage medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, DDR RAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems, and execution environments/containers.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method, comprising:
obtaining state data of a movable platform, scene data of an environment within which the movable platform is simulated, and parameters of one or more imaging sensors borne on the movable platform;
varying one or more of the state data, the scene data, and the parameters to obtain varied data; and
simulating visual data captured by the one or more imaging sensors based on the varied data for the one or more of state data, the scene data, and the parameters.

2. The method of claim 1, further comprising:
simulating one or more visual effects based on the variation of the one or more of the state data, the scene data, and the parameters.

3. The method of claim 2, further comprising:
processing the simulated visual data with the simulated one or more visual effects; and
simulating an operation of the movable platform in accordance with the processing.

4. The method of claim 1, wherein the one or more imaging sensors include one or more pairs of imaging sensors of a visual odometry system.

5. The method of claim 1, wherein the state data of the movable platform includes at least one of a displacement, a velocity, an acceleration, an attitude, an angular velocity, an angular acceleration, a longitude, a latitude, or a height of the movable platform.

6. The method of claim 5, wherein the state data includes simulated data obtained from a state simulator configured to implement one or more operation models to simulate one or more operation states of the movable platform.

7. The method of claim 1, wherein the parameters of the one or more imaging sensors include one or more intrinsic parameters and/or one or more extrinsic parameters of the one or more imaging sensors, the one or more intrinsic parameters including at least one of focal length, zooming information, or depth of focus (DOF), and the one or more extrinsic parameters including positional information of the one or more imaging sensors.

8. The method of claim 1, further comprising:
processing the visual data to obtain operation data of the movable platform;
simulating control signals based on the operation data; and
updating the state data of the movable platform in accordance with control signals.

9. A system for simulating visual data of a movable platform, the system comprising:
one or more processors; and
memory storing one or more programs configured to be executed by the one or more processors, the one or more programs including instructions for:
obtaining state data of a movable platform, scene data of an environment within which the movable platform is simulated, and parameters of one or more imaging sensors borne on the movable platform;
varying one or more of the state data, the scene data, and the parameters to obtain varied data; and
simulating visual data captured by the one or more imaging sensors based on the varied data for the one or more of state data, the scene data, and the parameters.

10. The system of claim 9, wherein the one or more programs further include instructions for displaying the simulated visual data on a monitor.

11. The system of claim 9, wherein the one or more programs further include instructions for simulating one or more visual effects based on the variation of the one or more of the state data, the scene data, and the parameters.

12. The system of claim 11, wherein the one or more programs further include instructions for processing the simulated visual data with the simulated one or more visual effects and simulating an operation of the movable platform in accordance with the processing.

13. The system of claim 9, wherein the one or more imaging sensors include one or more pairs of imaging sensors of a visual odometry system.

14. The system of claim 9, wherein the state data of the movable platform comprises at least one of a displacement, a velocity, an acceleration, an attitude, an angular velocity, an angular acceleration, a longitude, a latitude, or a height of the movable platform.

15. The system of claim 14, wherein the state data includes simulated data obtained from a state simulator configured to implement one or more models to simulate one or more states of the movable platform.

16. The system of claim 9, wherein the parameters of the one or more imaging sensors comprise one or more intrinsic parameters or one or more extrinsic parameters of the one or more imaging sensors, wherein the one or more intrinsic parameters include at least one of focal length, zooming information, or depth of focus (DOF), and wherein the one or more extrinsic parameters includes positional information of the one or more imaging sensors.

17. The system of claim 9, wherein the simulated visual data corresponds to a first-person-view of the one or more imaging sensors.

18. The system of claim 9, wherein the one or more programs further include instructions for storing the state data, the scene data, the parameters, and the simulated visual data associated with each image frame in a memory device.

19. The system of claim 9, wherein the one or more programs further include instructions for:
processing the visual data to obtain operation data of the movable platform;
simulating control signals based on the operation data; and
updating the state data of the movable platform in accordance with control signals.

20. A method, comprising:
receiving a first set of data of a movable platform simulated within a virtual environment, the first set of data being determined by state data of the movable platform and scene data of the environment;
obtaining a second set of data of the movable platform, the second set of data being determined based on visual data that is simulated from the state data, the scene data, and parameters of one or more imaging sensors borne on the movable platform;
determining a first indicator corresponding to the first set of data and a second indicator corresponding to the second set of data; and
outputting a comparison result between the first indicator and the second indicator.
